(19) United States
(12) Patent Application Publication
(10) Pub. No.: US 2022/0121566 A1
(43) Pub. Date: Apr. 21, 2022

(54) METHODS, SYSTEMS, ARTICLES OF MANUFACTURE AND APPARATUS FOR NETWORK SERVICE MANAGEMENT

(71) Applicant: Intel Corporation, Santa Clara, CA (US)

(72) Inventors: Francesc Guim Bernat, Barcelona (ES); Karthik Kumar, Chandler, AZ (US); Thomas Willhalm, Sandhausen (DE); Alexander Bachmutsky, Sunnyvale, CA (US); Marcos Carranza, Portland, OR (US)

(21) Appl. No.: 17/561,167

(22) Filed: Dec. 23, 2021

(51) Int. Cl. G06F 12/02; G06F 15/78

(52) U.S. Cl. CPC G06F 12/0292; G06F 2212/654; G06F 15/7839

(57) ABSTRACT

Methods, apparatus, systems, and articles of manufacture are disclosed for network service management. An example apparatus includes microservice translation circuitry to query, at a first time, a memory address range corresponding to a plurality of services, and generate state information corresponding to the plurality of services at the first time. The example apparatus also includes microservice request circuitry to query, at a second time, the memory address range to identify a memory address state change, the memory address state change indicative of an instantiation request for at least one of the plurality of services, and microservice instantiation circuitry to cause a first compute device to instantiate the at least one of the plurality of services.

### FIELD OF THE DISCLOSURE

This disclosure relates generally to network services and, more particularly, to methods, systems, articles of manufacture and apparatus for network service management.

### BACKGROUND

In recent years, Edge networking environments have experienced increasing demands for services from different portions of the Edge networking environment, such as services from cloud service providers. Typically, services are decomposed into modular services referred to as “microservices.” Additionally, microservices may be containerized to operate in a more “self contained” manner when needed.

### BRIEF DESCRIPTION OF THE DRAWINGS

FIG. A1 illustrates an overview of an Edge cloud configuration for Edge computing.

FIG. A2 illustrates operational layers among endpoints, an Edge cloud, and cloud computing environments.

FIG. A3 illustrates an example approach for networking and services in an Edge computing system.

FIG. B1 illustrates deployment of a virtual Edge configuration in an Edge computing system operated among multiple Edge nodes and multiple tenants.

FIG. B2 illustrates various compute arrangements deploying containers in an Edge computing system.

FIG. D2 is a schematic diagram of an example infrastructure processing unit (IPU).

FIG. 1 is a block diagram of an example architecture of a microservice management system to manage microservice execution consistent with teachings of this disclosure.

FIG. 2 is a block diagram of example microservice management circuitry constructed in a manner consistent with teachings of this disclosure.

FIGS. 3 and 4 are flowcharts representative of example machine readable instructions and/or example operations that may be executed by example processor circuitry to implement the example architecture of FIG. 1 and the example microservice management circuitry of FIG. 2.

FIG. 5 is a block diagram of an example processing platform including processor circuitry structured to execute the example machine readable instructions and/or the example operations of FIGS. 3 and 4 to implement the example architecture of FIG. 1 and the example microservice management circuitry of FIG. 2.

FIG. 6 is a block diagram of an example implementation of the processor circuitry of FIG. 5.

FIG. 7 is a block diagram of another example implementation of the processor circuitry of FIG. 5.

FIG. 8 is a block diagram of an example software distribution platform (e.g., one or more servers) to distribute software (e.g., software corresponding to the example machine readable instructions of FIGS. 3 and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Edge services are not always deterministic. While some tasks can be predicted in advance of their need (e.g., a time-of-day expectation for increased traffic), other tasks may become needed without any advanced warning. In an effort to combat this uncertainty, typical microservice management systems in Edge networks require at least one instance of a particular microservice running in at least one Edge node of the Edge network(s). As used herein, a “microservice” is a decomposed (e.g., divided, split, allocated, etc.) service that would otherwise operate in a monolithic architecture. Unlike a monolithic architecture that bundles a large number of services into an application (app), and aggregates data storage into a single monolithic data source (e.g., a database) from which numerous apps and services rely, microservices are decomposed into smaller and/or otherwise more responsive services that, in some examples, have their own data storage and app framework. Microservices may include one or more functions that can be invoked and executed when the microservice is also instantiated and executing. Because microservices are relatively more nimble than their monolithic counterparts, individual microservices can be “spun-up” and instantiated faster than monolithic architectures. Microservices typically consume a smaller form factor or footprint, such as a smaller amount of consumed memory (e.g., an executable or bit stream stored in memory, disk storage, etc.). The relatively smaller form factor facilitates faster instantiation times and less bandwidth consumption. In some instances, examples disclosed herein apply to Edge networking services in the same manner as microservices. In other words, concepts disclosed herein to manage “microservices” may apply to concepts corresponding to “services.”

Of course, depending on a particular load at any particular time, some services (e.g., microservices) are not needed and/or are not performing any useful tasks, yet still consuming a portion of node resources to remain ready for invocation. In some examples, microservices are instantiated so that they can either execute one or more desired tasks/functions (e.g., an active phase) or remain in hibernation (e.g., a dormant or hibernated phase in which the microservice binary is stored in disk storage, or stored in relatively faster cache memory in case it is expected to be needed sooner or lower latency is required for function execution). In some examples, services can also be hibernated. In some examples, particular services include a footprint that is too large for a relatively fast cache memory and, as such, are not candidates for hibernation. To instantiate a microservice, at least one fetch (e.g., a memory fetch for an executable/binary) is required so that the microservice is available in, for example, cache memory. Additionally, while a hibernated microservice can be further instantiated (e.g., brought into an operational/active phase) in a responsive manner because it is in cache memory, resources are still consumed to keep the microservice at some level of readiness. Stated differently, resources are wasted (e.g., in an effort to satisfy service level agreements (SLAs)).

Such waste is compounded as services, networks and/or systems attempt to scale up. While employing microservices and/or containerized microservices is an improvement over monolithic architectures, the aggregated waste of scale up efforts still cannot be ignored. Examples disclosed herein manage microservice execution in a manner that improves responsivity and efficiency.

FIG. A1 is a block diagram A100 showing an overview of a configuration for Edge computing, which includes a layer of processing referred to in many of the following examples as an “Edge cloud”. As shown, the Edge cloud A110 is co-located at an Edge location, such as an access point or base station A140, a local processing hub A150, or a central office A120, and thus may include multiple entities, devices, and equipment instances. The Edge cloud A110 is located much closer to the endpoint (consumer and producer) data sources A160 (e.g., autonomous vehicles A161, user equipment A162, business and industrial equipment A163, video capture devices A164, drones A165, smart cities and building devices A166, sensors and IoT devices A167, etc.) than the cloud data center A130. Compute, memory, and storage resources which are offered at the edges in the Edge cloud A110 are critical to providing ultra-low latency response times for services and functions used by the endpoint data sources A160 as well as reduce network backhaul traffic from the Edge cloud A110 toward cloud data center A130 thus improving energy consumption and overall network usages among other benefits.

Compute (e.g., processor cycles), memory, and storage are scarce resources, and may generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to workload data where appropriate, or, bring the workload data to the compute resources. In some examples, a workload includes, but is not limited to executable processes, such as algorithms, machine learning algorithms, image recognition algorithms, gain/loss algorithms, etc.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. A2 illustrates operational layers among endpoints, an Edge cloud, and cloud computing environments. Specifically, FIG. A2 depicts examples of computational use cases A205, utilizing the Edge cloud A110 among multiple illustrative layers of network computing. The layers begin at an endpoint (devices and things) layer A200, which accesses the Edge cloud A110 to conduct data creation, analysis, and data consumption activities. The Edge cloud A110 may span multiple network layers, such as an Edge devices layer A210 having gateways, on-premise servers, or network equipment (nodes A215) located in physically proximate Edge systems; a network access layer A220, encompassing base stations, radio processing units, network hubs, regional data centers (DC), or local network equipment (equipment A225); and any equipment, devices, or nodes located therebetween (in layer A212, not illustrated in detail). The network communications within the Edge cloud A110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer A200, under 5 ms at the Edge devices layer A210, to even between 10 to 40 ms when communicating with nodes at the network access layer A220. Beyond the Edge cloud A110 are core network A230 and cloud data center A240 layers, each with increasing latency (e.g., between 50-60 ms at the core network layer A230, to 100 or more ms at the cloud data center layer). As a result, operations at a core network data center A235 or a cloud data center A245, with latencies of at least 50 to 100 ms or more, will not be able to accomplish many time-critical functions of the use cases A205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center A235 or a cloud data center A245, a central office or content data network may be considered as being located within a “near Edge” layer (“near” to the cloud, having high latency values when communicating with the devices and endpoints of the use cases A205), whereas an access point, base station, on-premise server, or network gateway may be considered as located within a “far Edge” layer (“far” from the cloud, having low latency values when communicating with the devices and endpoints of the use cases A205). It will be understood that other categorizations of a particular network layer as constituting a “close”, “local”, “near”, “middle”, or “far” Edge may be based on latency, distance, number of network hops, or other measurable characteristics, as measured from a source in any of the network layers A200-A240.

The various use cases A205 may access resources under usage pressure from incoming streams, due to multiple services utilizing the Edge cloud. To achieve results with low latency, the services executed within the Edge cloud A110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate. In some examples, an SLA is an agreement, commitment and/or contract between entities. The SLA may include parameters (e.g., latency) and corresponding values (e.g., time in milliseconds) that must be satisfied before the SLA is deemed in compliance or not.

Thus, with these variations and service features in mind, Edge computing within the Edge cloud A110 may provide the ability to serve and respond to multiple applications of the use cases A205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud A110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud A110 (network layers A200-A240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud A110.

As such, the Edge cloud A110 is formed from network components and functional features operated by and within Edge gateway nodes, Edge aggregation nodes, or other Edge compute nodes among network lasers A210-A230. The Edge cloud A110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud A110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

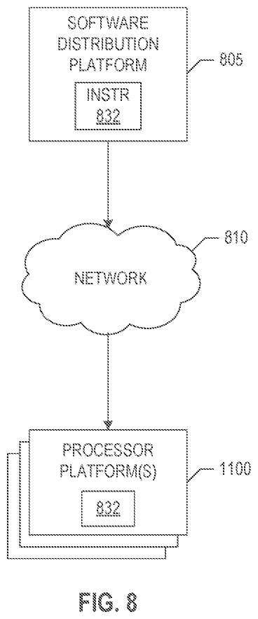

The network components of the Edge cloud A110 may be servers, multi-tenant servers, appliance computing devices, and/or an other type of computing devices. For example, the Edge cloud A110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances. Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 8-10, described in further detail below. The Edge cloud A110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

In FIG. A3, various client endpoints A310 (in the form of mobile devices, computers, autonomous vehicles, business computing equipment, industrial processing equipment) exchange requests and responses that are specific to the type of endpoint network aggregation. For instance, client endpoints A310 may obtain network access via a wired broadband network, by exchanging requests and responses A322 through an on-premise network system A332. Some client endpoints A310, such as mobile computing devices, may obtain network access via a wireless broadband network, by exchanging requests and responses A324 through an access point (e.g., cellular network tower) A334. Some client endpoints A310, such as autonomous vehicles may obtain network access for requests and responses A326 via a wireless vehicular network through a street-located network system A336. However, regardless of the type of network access, the TSP may deploy aggregation points A342, A344 within the Edge cloud A110 to aggregate traffic and requests. Thus, within the Edge cloud A110, the TSP may deploy various compute and storage resources, such as at Edge aggregation nodes A340, to provide requested content. The Edge aggregation nodes A340 and other systems of the Edge cloud A110 are connected to a cloud or data center A360, which uses a backhaul network A350 to fulfill higher-latency requests from a cloud/data center for websites, applications, database servers, etc. Additional or consolidated instances of the Edge aggregation nodes A340 and the aggregation points A342, A344, including those deployed on a single server framework, may also be present within the Edge cloud A110 or other areas of the TSP infrastructure.

FIG. B1 illustrates deployment and orchestration for virtualized and container-based Edge configurations across an Edge computing system operated among multiple Edge nodes and multiple tenants (e.g., users, providers) which use such Edge nodes. Specifically, FIG. B1 depicts coordination of a first Edge node B122 and a second Edge node B124 in an Edge computing system B100, to fulfill requests and responses for various client endpoints B110 (e.g., smart cities/building systems, mobile devices, computing devices, business/logistics systems, industrial systems, etc.), which access various virtual Edge instances. Here, the virtual Edge instances B132, B134 provide Edge compute capabilities and processing in an Edge cloud, with access to a cloud/data center B140 for higher-latency requests for websites, applications, database servers, etc. However, the Edge cloud enables coordination of processing among multiple Edge nodes for multiple tenants or entities.

In the example of FIG. B1, these virtual Edge instances include a first virtual Edge B132, offered to a first tenant (Tenant 1), which offers a first combination of Edge storage, computing, and services; and a second virtual Edge B134, offered to a second tenant (Tenant 2), which offers a second combination of Edge storage, computing, and services. The virtual Edge instances B132, B134 are distributed among the Edge nodes B122, B124, and may include scenarios in which a request and response are fulfilled from the same or different Edge nodes. The configuration of the Edge nodes B122, B124 to operate in a distributed yet coordinated fashion occurs based on Edge provisioning functions B150. The functionality of the Edge nodes B122, B124 to provide coordinated operation for applications and services, among multiple tenants, occurs based on orchestration functions B160.

It should be understood that some of the devices in B110 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice mas be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective Edge nodes B122, B124 may operate as security feature enforcement points for local resources allocated to multiple tenants per node. Additionally, tenant runtime and application execution (e.g., in instances B132, B134) may serve as an enforcement point for a security feature that creates a virtual Edge abstraction of resources spanning potentially multiple physical hosting platforms. Finally, the orchestration functions B160 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, servlets, servers, or other computation abstraction that may be partitioned according to a DICE layering and fan-out structure to support a RoT context for each. Accordingly, the respective RoTs spanning devices B110, B122, and B140 may coordinate the establishment of a distributed trusted computing base (DTCB) such that a tenant-specific virtual trusted secure channel linking all elements end to end can be established.

Further, it will be understood that a container may have data or workload specific keys protecting its content from a previous Edge node. As part of migration of a container, a pod controller at a source Edge node may obtain a migration key from a target Edge node pod controller where the migration key is used to wrap the container-specific keys. When the container/pod is migrated to the target Edge node, the unwrapping key is exposed to the pod controller that then decrypts the wrapped keys. The keys may now be used to perform operations on container specific data. The migration functions may be gated by properly attested Edge nodes and pod managers (as described above).

In further examples, an Edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. B1. For instance, an Edge computing system may be configured to fulfill requests and responses for various client endpoints from multiple virtual Edge instances (and, from a cloud or remote data center). The use of these virtual Edge instances may support multiple tenants and multiple applications (e.g., augmented reality (AR)/virtual reality (VR), enterprise applications, content delivery, gaming, compute offload, etc.) simultaneously. Further, there may be multiple types of applications within the virtual Edge instances (e.g., normal applications; latency sensitive applications; latency-critical applications; user plane applications; networking applications; etc.). The virtual Edge instances may also be spanned across systems of multiple owners at different geographic locations (or, respective computing systems and resources which are co-owned or co-managed by multiple owners).

For instance, each Edge node B122, B124 may implement the use of containers, such as with the use of a container “pod” B126, B128 providing a group of one or more containers. In a setting that uses one or more container pods, a pod controller or orchestrator is responsible for local control and orchestration of the containers in the pod. Various Edge node resources (e.g., storage, compute, services, depicted with hexagons) provided for the respective Edge slices B132, B134 are partitioned according to the needs of each container.

With the use of container pods, a pod controller oversees the partitioning and allocation of containers and resources. The pod controller receives instructions from an orchestrator (e.g., orchestrator B160) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, the pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator B160 may provision an attestation verification policy to local pod controllers that perform attestation verification. If an attestation satisfies a policy for a first tenant pod controller but not a second tenant pod controller, then the second pod could be migrated to a different Edge node that does satisfy it. Alternatively, the first pod may be allowed to execute and a different shared pod controller is installed and invoked prior to the second pod executing.

FIG. B2 illustrates additional compute arrangements deploying containers in an Edge computing system. As a simplified example, system arrangements B210, B220 depict settings in which a pod controller (e.g., container managers B211, B221, and container orchestrator B231) is adapted to launch containerized pods, functions, and FaaS instances through execution via compute nodes (B215 in arrangement B210), or to separately execute containerized virtualized network functions through execution via compute nodes (B223 in arrangement B220). This arrangement is adapted for use of multiple tenants in system arrangement B230 (using compute nodes B237), where containerized pods (e.g., pods B212), functions (e.g., functions B213, VNFs B222, B236), and functions-as-a-service instances (e.g., FaaS instance B214) are launched within virtual machines (e.g., VMs B234, B235 for tenants B232, B233) specific to respective tenants (aside the execution of virtualized network functions). This arrangement is further adapted for use in system arrangement B240, which provides containers B242, B243, or execution of the various functions, applications, and functions on compute nodes B244, as coordinated by a container-based orchestration system B241.

The system arrangements depicted in FIG. B2 provide an architecture that treats VMs, Containers, and Functions equally in terms of application composition (and resulting applications are combinations of these three ingredients). Each ingredient may involve use of one or more accelerator (e.g., FPGA, ASIC, etc.) components as a local backend. In this manner, applications can be split across multiple Edge owners, coordinated by an orchestrator.

In the context of FIG. B2, the pod controller/container manager, container orchestrator, and individual nodes may provide a security enforcement point. However, tenant isolation may be orchestrated where the resources allocated to a tenant are distinct from resources allocated to a second tenant, but Edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by Edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an Edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

FIG. D2 depicts an example of an infrastructure processing unit (IPU). Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. D2, the IPU D200 includes or otherwise accesses secure resource managing circuitry D202, network interface controller (NIC) circuitry D204, security and root of trust circuitry D206, resource composition circuitry D208, time stamp managing circuitry D210, memory and storage D212, processing circuitry D214, accelerator circuitry D216, and/or translator circuitry D218. Any number and/or combination of other structure(s) can be used such as but not limited to compression and encryption circuitry D220, memory management and translation unit circuitry D222, compute fabric data switching circuitry D224, security policy enforcing circuitry D226, device virtualizing circuitry D228, telemetry, tracing, logging and monitoring circuitry D230, quality of service circuitry D232, searching circuitry D234, network functioning circuitry (e.g., routing, firewall, load balancing, network address translating (NAT), etc.) D236, reliable transporting, ordering, retransmission, congestion controlling circuitry D238, and high availability, fault handling and migration circuitry D240 shown in FIG. D2. Different examples can use one or more structures (components) of the example IPU D200 together or separately. For example, compression and encryption circuitry D220 can be used as a separate service or chained as part of a data flow with vSwitch and packet encryption.

In some examples, IPU D200 includes a field programmable gate array (FPGA) D270 structured to receive commands from an CPU, XPU, or application via an API and perform commands/tasks on behalf of the CPU, including workload management and offload or accelerator operations. The illustrated example of FIG. D2 may include any number of FPGAs configured and/or otherwise structured to perform any operations of any IPU described herein.

Example compute fabric circuitry D250 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry D260 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU D200, IPU D200 is a root of a system (e.g., rack of servers or data center) and manages compute resources (e.g., CPU, xPU, storage, memory, other IPUs, and so forth) in the IPU D200 and outside of the IPU D200. Different operations of an IPU are described below.

In some examples, the IPU D200 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU D200 is selected to perform a workload, secure resource managing circuitry D202 offloads work to a CPU, xPU, or other device and the IPU D200 accelerates connectivity of distributed runtimes, reduce latency, CPU and increases reliability.

In some examples, secure resource managing circuitry D202 runs a service mesh to decide what resource is to execute workload, and provide for L7 (application layer) and remote procedure call (RPC) traffic to bypass kernel altogether so that a user space application can communicate directly with the example IPU D200 (e.g., IPU D200 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU D200 dynamically selects itself to run a given workload (e.g., microservice) within a composable infrastructure including an IPU, xPU, CPU, storage, memory, and other devices in a node.

In some examples, communications transit through media interfacing circuitry D260 of the example IPU D200 through a NIC/smartNIC (for cross node communications) or loopback back to a local service on the same host. Communications through the example media interfacing circuitry D260 of the example IPU D200 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU D200 prioritizes its processing to minimize the stalling of the requesting application. In some examples, the IPU D200 schedules the prioritized message request issuing the event to execute a SQL query database and the example IPU constructs microservices that issue SQL queries and the queries are sent to the appropriate devices or services.

As described above, the non-deterministic nature of Edge networks requires techniques to ensure SLA expectations are met. For example, video analytics use case scenarios may require identification of safety issues in a city. Traditionally, applications would consume one or more video streams from corresponding camera and/or image acquisition devices. Such applications may recompose the streams and perform object and/or person detection so that safety issues can be identified. However, the example use case in an Edge network becomes hardware limited when scale up efforts are attempted. In view of SLA expectations that microservices must be responsive, traditional microservice applications require resource allocation to each microservice and a corresponding instantiation effort. However, when scaling up one thousand or ten thousand fold, hardware limitation become a burdensome barrier when traditional microservices must be instantiated and running, despite no current demand for particular ones of those microservices. Examples disclosed herein improve responsivity and efficiency of managing microservice instantiation and execution.

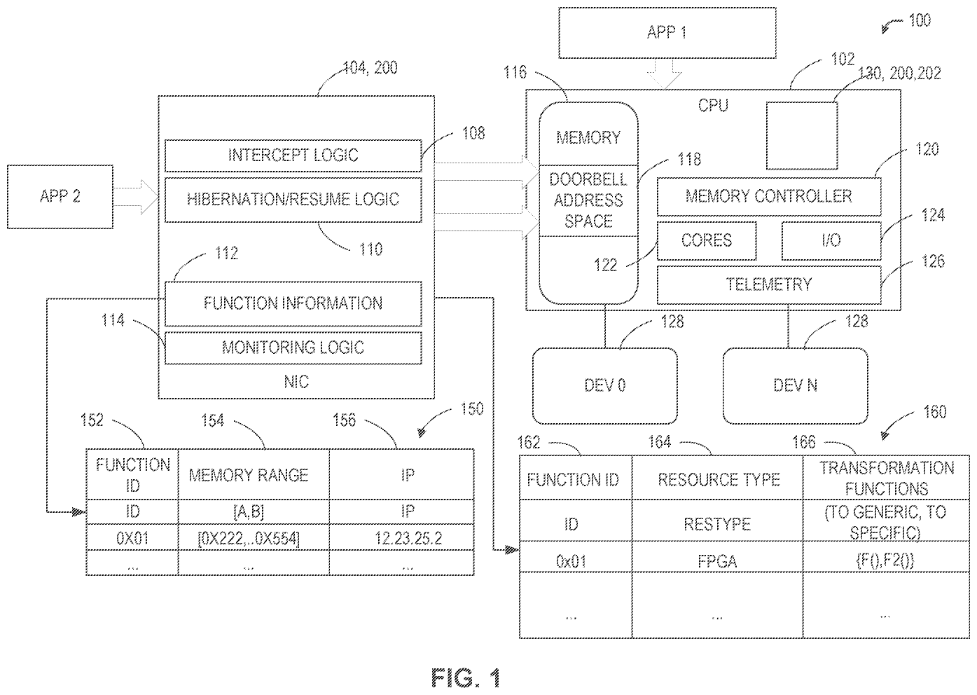

FIG. 1 is an example architecture of a microservice management system 100. In the illustrated example of FIG. 1, the microservice management system 100 includes an example CPU 102 that is representative of one of any number of Edge nodes that may operate in an Edge network. However, examples disclosed herein are not limited to Edge nodes using a CPU, as any other type of computing device may be considered without limitation (e.g., a GPU, an FPGA, an accelerator, and/or any combinations thereof). The example microservice management system 100 also includes an example network interface card (NIC) 104, which is sometimes referred to herein as a smartNIC. While the illustrated example of FIG. 1 includes the smartNIC 104, examples disclosed herein may include, additionally or alternatively, an example IPU to facilitate responsivity and efficiency improvements of microservice implementation in an Edge network. Additionally, while the example smartNIC 104 is shown in the illustrated example of FIG. 1 as a separate structure of the CPU 102, examples disclosed herein include architectures where the example CPU 102 includes the structure and/or logic of the example smartNIC 104.

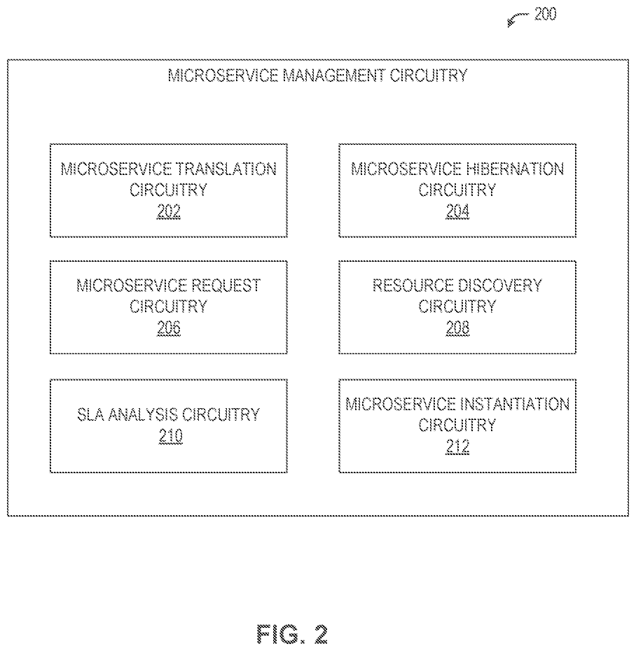

The example smartNIC 104 includes microservice management circuitry, which is described in further detail below. Such microservice management circuitry includes example intercept logic 108, example hibernation/resume logic 110, example function information 112, and example monitoring logic 114. The example CPU 102 of FIG. 1 includes example memory 116, which includes example doorbell address space 118. The example CPU 102 of FIG. 1 also includes an example memory controller 120, one or more cores 122, I/O circuitry 124, and telemetry circuitry 126. The example CPU 102 includes any number of devices 128 that can be invoked by microservices (e.g., in response to an application making one or more requests to one or more microservices to enable and/or otherwise utilize the devices 128). The example CPU 102 also includes example microservice translation circuitry 130 (which is also referred to in FIG. 2 as element 202) and/or, more generally, microservice management circuitry (which is also referred to in FIG. 2 as element 200).

In operation, the example smartNIC 102 (which includes structure and/or logic corresponding to the example microservice management circuitry to be discussed in further detail below) invokes the example intercept logic 108 to intercept requests for functions to be executed by one or more microservices. In some examples, the intercept logic 108 utilizes a compute express link (CXL) open standard to facilitate high-speed CPU-to-device (e.g., other CPUs, memory, etc.) communication, but examples disclosed herein are not limited thereto. In particular, the example intercept logic 108 monitors the example doorbell address space 118 for address/memory ranges identified by particular functions requested by an application local to the CPU 102 (e.g., functions requested by the example App 1 of FIG. 1) and/or address/memory ranges corresponding to particular functions requested by an application (e.g., App 2 of FIG. 1). Requesting software stacks, such as App 1 and/or App 2 of FIG. 1 are memory range aware of the functions being requested/invoked and need to identify an appropriate address range in the function invocation request.

FIG. 1 includes an example function lookup table 150 that is known and/or otherwise available to any application that desires to invoke microservices (which are responsible for invoking particular functions) of Edge nodes. The example function lookup table 150 of FIG. 1 includes a function identifier column 152, a memory range column 154 and an IP address column 156. In the event App 2 makes a request for a particular function, such as function 0x01 (see the function identifier column 152), the example function information circuitry 112 helps to transmit and/or otherwise provide the corresponding memory address range (see the memory range column 154) with a corresponding bit or flag write request to indicate initiation of the requested function. In some examples, an IP address (see the IP address column 156) may be used to identify particular doorbell address spaces that are to be flagged for invocation with a write request. In some examples, the hibernation/resume logic 110 determines that a microservice was previously instantiated and located in a memory or a cache memory for fast activation.

In some examples, the request for function invocation may not satisfy SLA requirements at the time of invocation. For instance, a prior function execution may have utilized the example CPU 102 to perform one or more tasks, and then placed in a hibernation state to avoid wasting resources during instances of non-use (e.g., stopping the microservice, but storing its state information in cache memory for fast re-retrieval). However, at a second/later time when the same microservice is invoked, the CPU may be inundated with alternate/active tasks, thereby causing SLA performance expectations to drop below threshold levels of acceptance. However, in the event the example CPU 102 includes alternate hardware resources that are capable of performing the functions corresponding to the invoked microservices, the example function information circuitry 112 includes an example transformation table 160. The example transformation table 160 includes an example function identifier column 162, an example resource type column 164 and an example transformation functions column 166. When faced with the threat of not satisfying SLA requirements, the example function information circuitry 112 provides any number of transformation functions to transform a previously targeted first hardware device to employ a different/second hardware device. In the illustrated example of FIG. 1, function ID 0x01 may have initially been configured to operate with a CPU, such as the example CPU 102 of FIG. 1, but the example transformation functions permit that same function to be implemented via an FPGA. In some examples, the transformation functions 166 of FIG. 1 are stored in a memory (e.g., a local memory 116) for retrieval when needed.

In some examples, the hibernation/resume logic 110 detects when a request is identified (e.g., via particular memory ranges identified in the request) and, if the desired function is not up, determine where to instantiate the function. As described above, the monitoring logic 114 may monitor the status of any number of available devices (e.g., the CPU 102, DEV 0 and/or DEV N (128)) to aid in the determination of where the function should be instantiated. In some examples, when other microservices are running, yet there has been no demand for one or more functions enabled by the microservices, the example hibernation/resume logic 110 causes one or more microservices to enter a hibernation state, thereby allocating additional computing resources for the node. In some examples, deciding which microservices to hibernate is based on a priority or importance metric of the request (e.g., a priority metric in App 1) or associated SLA information corresponding to a function of interest.

The example monitoring logic 114 also monitors and/or otherwise tracks how often functions are executed, as well as monitoring memory regions where requests are queued. Hibernation decisions can be made to store hibernated functions in persistent memory (for later fast retrieval) or disk storage (e.g., when imminent re-use is not anticipated). Monitored parameters that illustrate a manner of determining which functions (and/or their corresponding microservices) are to be hibernated include, but are not limited to a particular frequency of use, a particular latency metric, or a particular importance (e.g., priority) of the function.

FIG. 2 is a schematic illustration of example microservice management circuitry 200 described above in connection with FIG. 1. While the illustrated example of FIG. 1 described generalities of the example microservice management circuitry 200, which operate primarily in the example smartNIC 104, examples disclosed herein are not limited thereto. As described above, the example microservice management circuitry 200 may be implemented in, for instance, an infrastructure processing unit (IPU), such as the example IPU D200 of FIG. D2. The example microservice management circuitry 200 of FIG. 2 includes example microservice translation circuitry 202, example microservice hibernation circuitry 204, example microservice request circuitry 206, example resource discovery circuitry 208, example SLA analysis circuitry 210 and example microservice instantiation circuitry 212.

In operation, the example microservice translation circuitry 202 queries the example doorbell address space 118 to obtain information regarding microservice status. As described above, examples disclosed herein may apply to services in some cases, thus the example microservice translation circuitry 202 is not limited to microservices. Microservice status includes information indicative of whether the microservice was ever instantiated in the past, whether the microservice was previously instantiated, but currently hibernated, and whether the microservice is currently running. As described above, each microservice of interest includes a particular memory address range in which data can be toggled and/or otherwise configured to identify a current state of the microservice on the node of interest (e.g., on the CPU 102). Based on the information retrieved from the query, the example microservice translation circuitry 202 updates the microservice state information stored in the example doorbell address space 118. In other words, the query results in obtaining state information for any number of microservices corresponding to the doorbell address space 118. For example, and briefly returning to the illustrated example of FIG. 1, consider that APP 1 (sometimes referred to as a software stack) initiated a microservice on a prior occasion. When APP 1 initiated its request for the microservice, it also had access to and/or awareness of the specific regions of the doorbell address space 118 that correspond to the requested microservice and, therefore, the example microservice translation circuitry 130 of the example CPU 102 updated the data within the doorbell address space 118 accordingly. In other words, the example microservice translation circuitry 130 caused the specific memory regions of the doorbell address space to reflect that the microservice is currently executing. Generally speaking, translation of a service already in a relatively faster (e.g., closer to the processor) memory is more efficient than translation efforts that require an alternate memory or disk fetch operation(s). In other examples, the microservice translation circuitry 202 conducts queries in a temporal manner so that one or more changes to microservice state information of the doorbell address space 118 can be identified. For example, a query at a first time may allow the state information to be stored in a memory, thus a second query at a second time permits changes to be detected. Such changes may be indicative of a microservice request occurring in an effort to instantiate that microservice. In some examples, the state change identifies a microservice that has been instantiated locally (e.g., under the control of the CPU 102). In other examples, the state change identifies a request for the microservice to be instantiated, such that the example microservice instantiation circuitry 212 causes the microservice to be instantiated on the compute device (e.g., on the example CPU 102, an a GPU, on an FPGA, etc.). As described above, examples disclosed herein may apply to services in some cases, thus the example microservice instantiation circuitry 212 is not limited to microservices.

However, also consider that the example microservice management system 100 of FIG. 1 is operating in a much larger Edge network. At the time APP 1 instantiated its microservice, this information is currently unknown to any other node of the Edge network. As such, consider that an external request APP 2 requests invocation of the same microservice that was instantiated via APP 1. To facilitate a much faster determination of which microservices are currently available or unavailable, examples disclosed herein utilize the example doorbell address space 118 memory regions to inform any query of microservice states. Continuing the example where the microservice is already running, that microservice is necessarily unavailable to APP 2 (after the smartNIC 104 performs a query of the corresponding memory address space). As described above and in further detail below, examples disclosed herein allow the ability for the microservice to be instantiated with alternate computing resources after the microservice is translated from the CPU target to another/separate target (e.g., an FPGA, a GPU, DEV 0, etc.).

After the example microservice translation circuitry 202 updates the microservice state information, the example microservice hibernation circuitry 204 updates microservice hibernation decisions. As described above, examples disclosed herein may apply to services in some cases, thus the example microservice hibernation circuitry 204 is not limited to microservices. For instance, in the event a particular microservice is not particularly active (e.g., the microservice satisfies one or more criteria indicative of inactivity, such as a frequency of invocation per unit of time), the example microservice hibernation circuitry 204 causes one or more microservices to hibernate. In some examples, the manner of hibernation differs based on different parameters, such as a priority value associated with the microservice. For instance, for microservices that are deemed very critical (e.g., based on SLA parameters) and/or invoked at a relatively high frequency, hibernation can be facilitated using persistent memory so that re-instantiation is fast. On the other hand, for microservices that are deemed less critical and/or invoked at a relatively low frequency, hibernation can be facilitated using disk storage, thereby conserving valuable high-speed memory of the target computing device.

While the above examples illustrate establishing a state of operation for any given node, the example microservice request circuitry 206 monitors for any incoming microservice request. As described above, examples disclosed herein may apply to services in some cases, thus the example microservice request circuitry 206 is not limited to microservices. Incoming microservice requests may occur due to external requests (e.g., Edge node network sourced requests, such as example APP 2), or requests that occur within the Edge node (e.g., APP 1). If no requests are detected based on detecting a difference in one or more address ranges of the example doorbell address space 118, monitoring and updating continues. However, in response to the example microservice request circuitry 206 detecting a microservice request, the example microservice hibernation circuitry 204 determines whether the requested microservice is already instantiated. If not, the example microservice instantiation circuitry 212 instantiates the requested microservice, and the microservice translation circuitry 202 updates the state information in the example doorbell address space 118 to reflect that the microservice is now instantiated. As such, any subsequent for this microservice will be met with a prompt status, thereby allowing the requestor to find an alternate node and/or instantiate the microservice wkith alternate computing resources.

However, if the microservice is already instantiated, as determined by the example microservice hibernation circuitry 204, the example resource discovery circuitry 208 identifies resources that implement the requested microservice. In some examples, the resource discover circuitry 208 examines the node (e.g., the CPU 102 and any communicatively connected computing devices) for computing devices. Results of such examination may identify that the particular node includes a CPU, a particular number of cores of the CPU, a particular availability of the number of cores of the CPU, a GPU, an FPGA, an accelerator, and/or availability of all such computing devices. The example SLA analysis circuitry 210 determines whether the SLA is expected to be satisfied when using the computing device associated with the microservice request. If so, the example microservice instantiation circuitry 212 spins-up and/or otherwise causes the microservice to operate (e.g., in some examples, the microservice was previously instantiated, but in a hibernated state). The example microservice translation circuitry 202 then updates the doorbell state information.

However, in the event the SLA is not expected to be satisfied when implementing the compute resources associated with the microservice request, as determined by the example SLA analysis circuitry 210, the example resource discovery circuitry 208 identifies one or more available compute resources. The example microservice translation circuitry 202 obtains translation binaries from the example transformation table 160 and translates the microservice so that the alternate compute device(s) can be used. Such updates to the microservice instantiation activity are again updated by the microservice translation circuitry 202 to the doorbell address space 118.

While examples disclosed above consider microservice responsivity and efficiency improvements managed by the example microservice management circuitry 200 operating in a smartNIC or an IPU, separate microservice translation circuitry 130, 202 may reside and/or otherwise operate on the example CPU 102 or other compute node within an Edge node device of an Edge network. As described above, microservice requests (and function requests) disclosed herein require a common knowledge of which functions correspond to which memory ranges in the example doorbell address space 118. As such, when the example smartNIC and/or IPU is “out of the loop” when the compute device internally instantiates a microservice (e.g., when APP 1 instantiates a microservice as a local operation), the example microservice translation circuitry 130 located in the corresponding compute device facilitates a proper lookup of the relevant memory address ranges that must be updated. As such, during the periodic, aperiodic and/or otherwise scheduled querying of the doorbell address space 118 by the smartNIC or IPU, such microservice operating changes are promptly discovered.

As described above, FIG. 2 is a block diagram of example microservice management circuitry 202 improve microservice responsivity and efficiency in an Edge networking environment. The example microservice management circuitry 202 of FIG. 2 may be instantiated (e.g., creating an instance of, bring into being for any length of time, materialize, implement, etc.) by processor circuitry such as a central processing unit executing instructions. Additionally or alternatively, the example microservice management circuitry 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

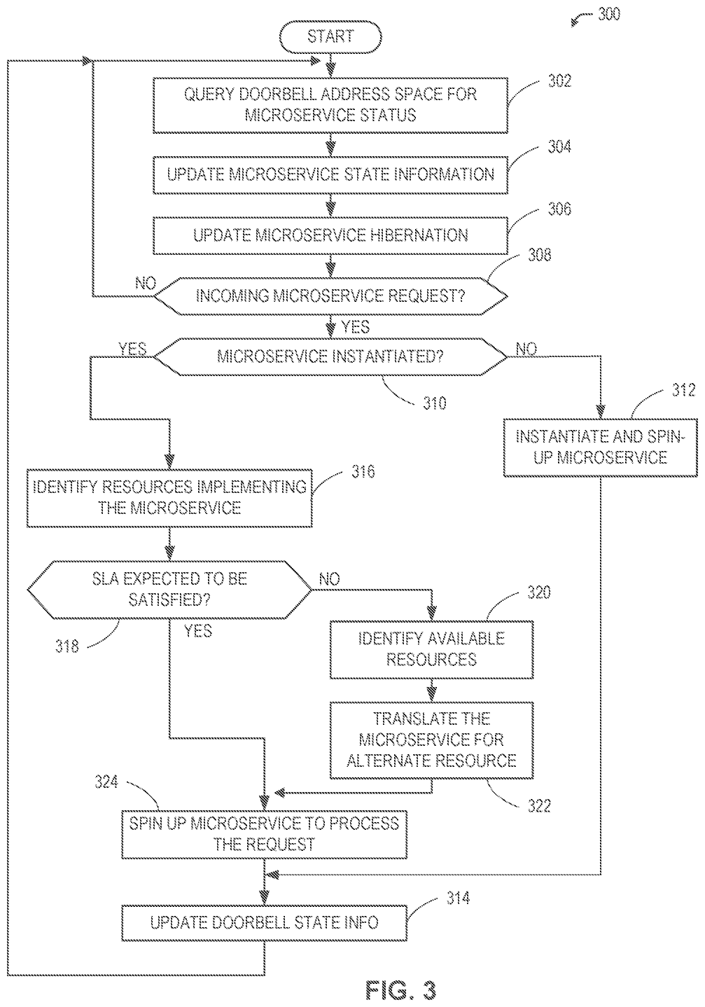

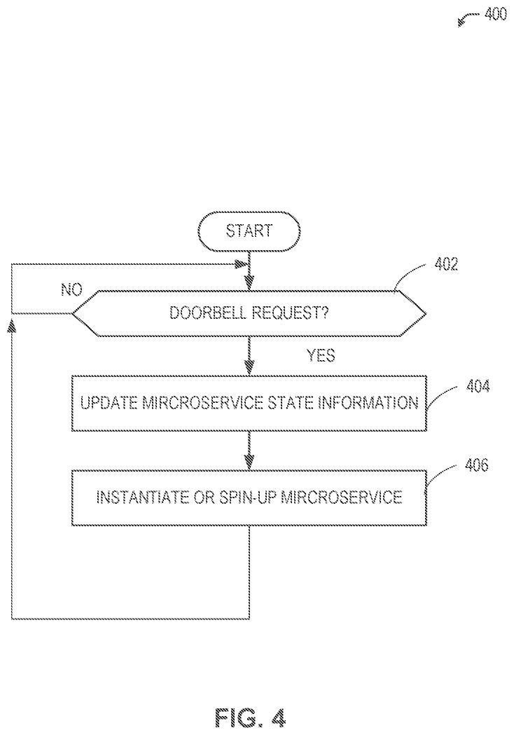

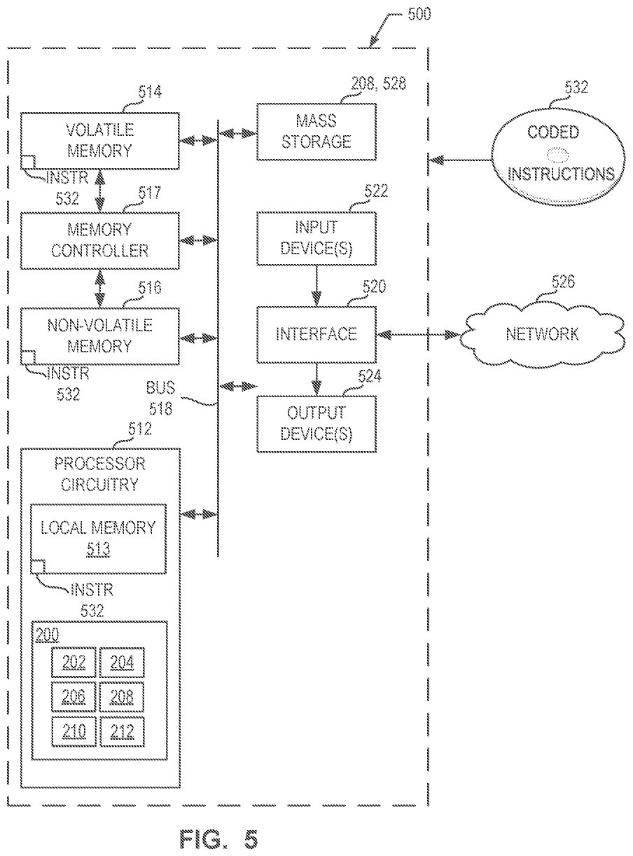

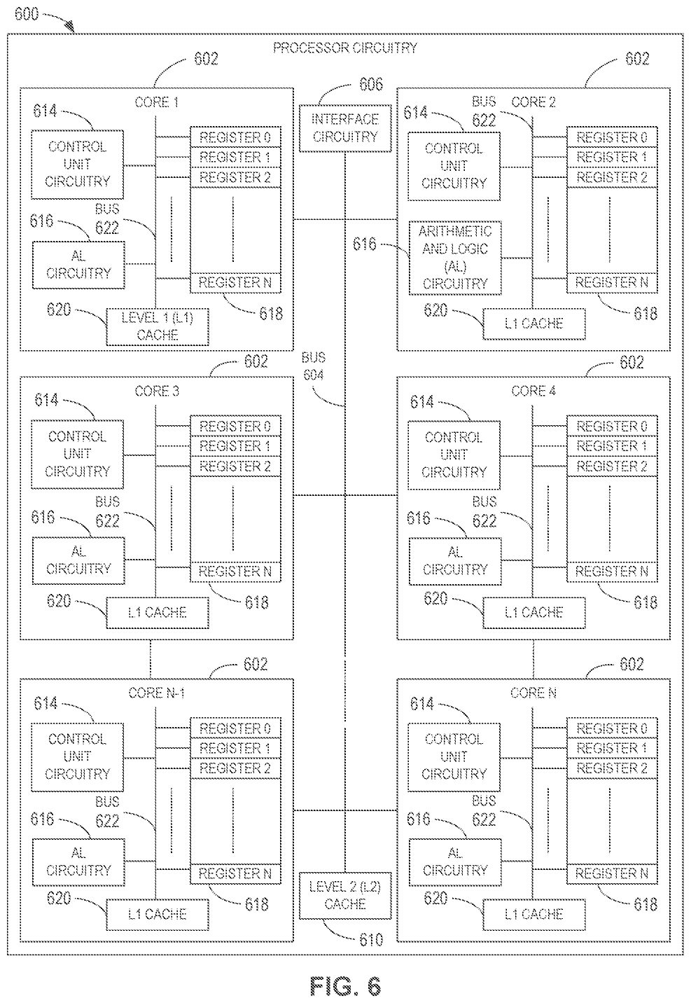

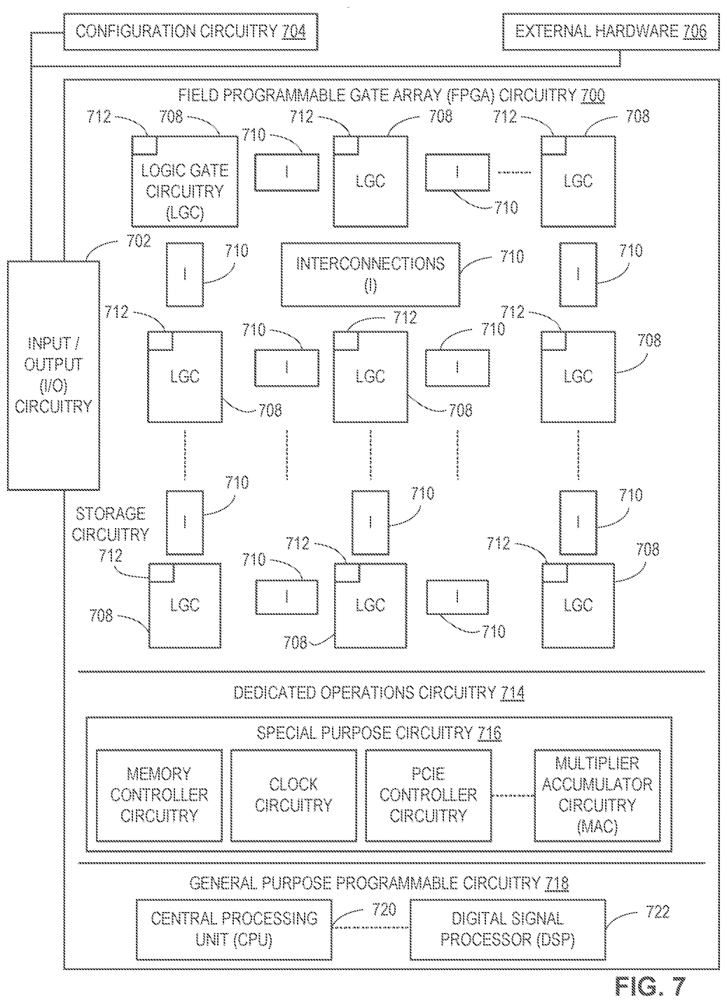

In some examples, the microservice translation circuitry 202 includes means for translating microservices, the microservice hibernation circuitry 204 includes means for hibernating services, the microservice request circuitry 206 includes means for requesting microservices, the resource discovery circuitry 208 includes means for discovering resources, the SLA analysis circuitry 210 includes means for analyzing SLA, the microservice instantiation circuitry 212 includes means for instantiating microservices, and the microservice management circuitry 200 includes means for managing microservices. For example, the means for translating microservices may be implemented by the example microservice translation circuitry 202, the means for hibernating services may be implemented by the example microservice hibernation circuitry 204, the means for requesting microservices may be implemented by the example microservice request circuitry 206, the means for discovering resources may be implemented by the example resource discovery circuitry 208, the means for analyzing SLA may be implemented by the example SLA analysis circuitry 210, the example means for instantiating microservices may be implemented by the example microservice instantiation circuitry 212, and the means for managing microservices may be implemented by the example microservice management circuitry 200. In some examples, the aforementioned circuitry may be instantiated by processor circuitry such as the example processor circuitry 512 of FIG. 5. For instance, the aforementioned circuitry may be instantiated by the example general purpose processor circuitry 600 of FIG. 6 executing machine executable instructions such as that implemented by at least blocks of FIGS. 3 and 4. In some examples, the aforementioned circuitry may be instantiated by hardware logic circuitry, which may be implemented by an ASIC or the FPGA circuitry 700 of FIG. 7 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the microservice management circuitry 200 of FIGS. 1 and 2 is illustrated in FIGS. 1 and 2, one or more of the elements, processes, and/or devices illustrated in FIGS. 1 and 2 may be combined, divided, re-arranged, omitted, eliminated, and/or implemented in any other way. Further, the example microservice translation circuitry 202, the example microservice hibernation circuitry 204, the example microservice request circuitry 206, the example resource discovery circuitry 208, the example SLA analysis circuitry 210, the example microservice instantiation circuitry 212, and/or, more generally, the example microservice management circuitry 200 of FIGS. 1 and 2, may be implemented by hardware alone or by hardware in combination with software and/or firmware. Thus, for example, any of the example microservice translation circuitry 202, the example microservice hibernation circuitry 204, the example microservice request circuitry 206, the example resource discovery circuitry 208, the example SLA analysis circuitry 210, the example microservice instantiation circuitry 212, and/or, more generally, the example microservice management circuitry 200 of FIGS. 1 and 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example microservice management circuitry 200 of FIGS. 1 and 2 may include one or more elements, processes, and/or devices in addition to, or instead of, those illustrated in FIGS. 1 and 2, and/or may include more than one of any or all of the illustrated elements, processes and devices.

Flowcharts representative of example hardware logic circuitry, machine readable instructions, hardware implemented state machines, and/or any combination thereof for implementing the microservice management circuitry 200 of FIGS. 1 and 2 are shown in FIGS. 3 and 4. The machine readable instructions may be one or more executable programs or portion(s) of an executable program for execution by processor circuitry, such as the processor circuitry 512 shown in the example processor platform 500 discussed below in connection with FIG. 5 and/or the example processor circuitry discussed below in connection with FIGS. 6 and/or 7. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3 and 4, many other methods of implementing the example microservice management circuitry 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to orchestrate microservices. The machine readable instructions and/or the operations 300 of FIG. 3 begin at block 302, at which the example microservice translation circuitry 202 queries doorbell address space to determine status information of microservices corresponding to the node. As described above, nodes in an Edge network may include any type and combination of resources (e.g., compute resources, memory resources, accelerator resources, etc.) that are utilized when microservices execute. In the event a particular microservice is operating on the Edge node, then that particular microservice cannot be instantiated again for another/separate requestor (e.g., one or more Edge nodes external to the local node). Generally speaking, blocks 302, 304, 306 and 308 correspond to determining a current status of microservice behavior and utilization on the Edge node prior to handling microservice instantiation requests. In other words, determining proper microservice instantiation behaviors first requires knowledge of which microservices are instantiated or not on the executing Edge node.

The example microservice translation circuitry 202 updates the microservice state information based on the query information retrieved from the example doorbell address space 118 (block 304). As described above, the manner of determining the state of the microservice is based on analyzing the information in particular memory address ranges that are dedicated to each particular microservice. By requiring requesting software stacks to identify microservices based on specific memory address ranges, subsequent determination efforts of microservice states can operate in a much faster manner when compared to initiating communication protocols within the Edge node. Instead, the example microservice translation circuitry 202 can quickly query bit state information of the specific microservice to determine if it is instantiated (e.g., bit state of one) or dormant/inactive (e.g., bit state of zero). Examples disclosed herein are not limited to binary state information of the specific memory address ranges, as the state information may also identify instances of microservices that are instantiated, but in a hibernated state. Still further, in some examples the state information determined by the example microservice translation circuitry 202 reveals information corresponding to memory locations where microservice executables are located (e.g., in persistent memory (e.g., fast retrieval), in disk storage (e.g., relatively slower retrieval), etc.).

The example microservice hibernation circuitry 204 updates microservice hibernation states based on metrics indicative of stale and/or otherwise under utilized microservices (block 306). Example metrics that, when satisfied in view of one or more thresholds, cause microservice hibernation include a particular frequency of microservice request, a particular priority value (e.g., criticality) associated with the microservice, etc.). The example microservice request circuitry 206 determines whether an microservice request has occurred (block 308). If not, control returns to block 302 to continue to monitor the state of microservice behaviors on the Edge device (e.g., on the example CPU 102 of FIG. 1). However, in response to the example microservice request circuitry 206 determining that a microservice request has occurred (block 308), the example microservice hibernation circuitry 204 determines whether the requested microservice is instantiated (block 310). If not, then the example microservice instantiation circuitry 212 instantiates the microservice on the Edge node (block 312). Additionally, the example microservice translation circuitry 202 updates the doorbell state information to track this change in microsenice activity (block 314).

However, if the example microservice hibernation circuitry 204 determines that the microservice has already been instantiated on the Edge node (block 310), then the example resource discovery circuitry 208 identifies which resources of the Edge node are to implement the requested microservice (block 316). The example SLA analysis circuitry 210 determines whether the SLA requirements will be satisfied in view of the identified resource that is expected and/or otherwise assigned to execute the requested microservice (block 318). As described above, one or more resources of an Edge node may experience utilization demands that are non-deterministic. As such, if the computing resource is inundated with other tasks from other tenants, then SLA parameters may not be satisfied if the microservice is assigned to that inundated compute resource In such a circumstance, the example resource discovery circuitry 208 identifies available resources of the Edge node (block 320), and the microservice translation circuitry 202 translates the microservice binaries for an alternate computing resource that can accommodate the microservice demands while also maintaining SLA performance expectations (block 322). The example microservice instantiation circuitry 212 then instantiates and/or otherwise spins-up the microservice so that its one or more functions and/or tasks can begin (block 324). Thereafter, the example microservice translation circuitry 202 updates the doorbell state information (block 314). In circumstances where the example SLA analysis circuitry 210 determines that SLA parameters will be satisfied (block 318), control advances to block 324, where the example microservice instantiation circuitry 212 instantiates and/or otherwise spins-up the microservice (block 324).

FIG. 4 is a flowchart representative of example machine readable instructions and/or example operations 400 that may be executed and/or instantiated by processor circuitry to orchestrate microservices. However, while the flowchart of FIG. 3 primarily relates to orchestration by a smart NIC or an IPU, the illustrated example of FIG. 4 includes instructions executed by an example computing device, such as the example CPU 102 of FIG. 1 (or any other computing device that will execute microservices). As described above, example improvements disclosed herein require that requestors of microservices make requests for such microservices by referencing a memory address range that corresponds to that microservice. Stated differently, all requestors make such requests in view of a common table (e.g., a lookup table) that identifies the desired microservice and a corresponding memory address range. As described above, each requestor may have access to the example function lookup table 150 shown in FIG. 1.

In the illustrated example of FIG. 4, the microservice translation circuitry 202 determines whether a doorbell request has occurred (block 402). If not, the example process 400 continues monitoring. However, in response to a doorbell request, the example microservice translation circuitry 202 updates the state information (block 404), and the example microservice instantiation circuitry 212 instantiates and/or otherwise spins-up the requested microservice (block 406).

FIG. 5 is a block diagram of an example processor platform 500 structured to execute and/or instantiate the machine readable instructions and/or the operations of FIGS. 3 and 4 to implement the example microservice management circuitry 200 of FIGS. 1 and 2. The processor platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a set top box, a headset (e.g., an augmented reality (AR) headset, a virtual reality (VR) headset, etc.) or other wearable device, or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs, microprocessors, CPUs, GPUs, DSPs, and/or microcontrollers from any desired family or manufacturer. The processor circuitry 512 may be implemented by one or more semiconductor based (e.g., silicon based) devices. In this example, the processor circuitry 512 implements the example microservice translation circuitry 202, the example microservice hibernation circuitry 204, the example microservice request circuitry 206, the example resource discovery circuitry 208, the example SLA analysis circuitry 210, the example microservice instantiation circuitry 212, and/or, more generally, the example microservice management circuitry 200 of FIGS. 1 and 2.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a key board, a button, a mouse, a touchscreen, a track-pad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 532, which may be implemented by the machine readable instructions of FIGS. 3 and 4, may be stored in the mass storage device 528, in the volatile memory 514, in the non-volatile memory 516, and/or on a removable non-transitory computer readable storage medium such as a CD or DVD.

FIG. 6 is a block diagram of an example implementation of the processor circuitry 512 of FIG. 5. In this example, the processor circuitry 512 of FIG. 5 is implemented by a general purpose microprocessor 600. The general purpose microprocessor circuitry 600 executes some or all of the machine readable instructions of the flowcharts of FIGS. 3 and 4 to effectively instantiate the circuitry of FIGS. 1 and 2 as logic circuits to perform the operations corresponding to those machine readable instructions. In some such examples, the circuitry of FIGS. 1 and 2 is instantiated by the hardware circuits of the microprocessor 600 in combination with the instructions. For example, the microprocessor 600 may implement multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3 and 4.

The cores 602 may communicate by a first example bus 604. In some examples, the first bus 604 may implement a communication bus to effectuate communication associated with one(s) of the cores 602. For example, the first bus 604 may implement at least one of an Inter-Integrated Circuit (I2C) bus, a Serial Peripheral Interface (SPI) bus, a PCI bus, or a PCIe bus. Additionally or alternatively, the first bus 604 may implement any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2_cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the L1 cache 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The second bus 622 may implement at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein A GPU or other programmable device can also be an accelerator. Accelerators may be on-board the processor circuitry, in the same chip package as the processor circuitry and/or in one or more separate packages from the processor circuitry.

FIG. 7 is a block diagram of another example implementation of the processor circuitry 512 of FIG. 5. In this example, the processor circuitry 512 is implemented by FPGA circuitry 700. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 3 and 4 but whose interconnections and logic circuitry are fixed once fabricated), the FPGA circuitry 700 of the example of FIG. 7 includes interconnections and logic circuitry that may be configured and/or interconnected in different ways after fabrication to instantiate, for example, some or all of the machine readable instructions represented by the flowcharts of FIGS. 3 and 4. In particular, the FPGA 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the flowcharts of FIGS. 3 and 4. As such, the FPGA circuitry 700 may be structured to effectively instantiate some or all of the machine readable instructions of the flowcharts of FIGS. 3 and 4 as dedicated logic circuits to perform the operations corresponding to those software instructions in a dedicated manner analogous to an ASIC. Therefore, the FPGA circuitry 700 may perform the operations corresponding to the some or all of the machine readable instructions of FIGS. 3 and 4 faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware (e.g., external hardware circuitry) 706. For example, the configuration circuitry 704 may implement interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may implement the microprocessor 600 of FIG. 6. The FPGA circuitry 700 also includes an array of example logic gate circuitry 708, a plurality of example configurable interconnections 710, and example storage circuitry 712. The logic gate circuitry 708 and interconnections 710 are configurable to instantiate one or more operations that may correspond to at least some of the machine readable instructions of FIGS. 3 and 4 and/or other desired operations. The logic gate circuitry 708 shown in FIG. 7 is fabricated in groups or blocks Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 70 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions represented by the flowcharts of FIGS. 3 and 4 may be executed by one or more of the cores 602 of FIG. 6, a second portion of the machine readable instructions represented by the flowcharts of FIGS. 3 and 4 may be executed by the FPGA circuitry 700 of FIG. 7, and/or a third portion of the machine readable instructions represented by the flowcharts of FIGS. 3 and 4 may be executed by an ASIC. It should be understood that some or all of the circuitry of FIGS. 1 and 2 may, thus, be instantiated at the same or different times. Some or all of the circuitry may be instantiated, for example, in one or more threads executing concurrently and/or in series. Moreover, in some examples, some or all of the circuitry of FIGS. 1 and 2 may be implemented within one or more virtual machines and/or containers executing on the microprocessor.

In some examples, the processor circuitry 512 of FIG. 5 may be in one or more packages. For example, the processor circuitry 600 of FIG. 6 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

A block diagram illustrating an example software distribution platform 805 to distribute software such as the example machine readable instructions 532 of FIG. 5 to hardware devices owned and/or operated by third parties is illustrated in FIGS. 1 and 2. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3 and 4, as described above. The one or more servers of the example software distribution platform 805 are in communication with a network 810, which may correspond to an one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIGS. 3 and 4, may be downloaded to the example processor platform 500, which is to execute the machine readable instructions 532 to implement the structure of FIGS. 1 and 2. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices.

From the foregoing, it will be appreciated that example systems, methods, apparatus, and articles of manufacture have been disclosed that improve the responsivity of microservice instantiation. In particular, examples disclosed herein enable microservices to be instantiated from a dormant and/or otherwise hibernated state in a manner that is faster than typical monolithic architectures are capable of implementing. Examples disclosed herein manage microservice state information and instantiation activity by using high speed memory range bit reads/writes to signal and control microservice behaviors.

Example methods, apparatus, systems, and articles of manufacture for network service management are disclosed herein. Further examples and combinations thereof include the following:

Example 1 includes an apparatus to invoke a service, the apparatus comprising interface circuitry detect a request to execute the service, and processor circuitry including one or more of at least one of a central processing unit (CPU), a graphic processing unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate microservice translation circuitry to query, at a first time, a memory address range corresponding to a plurality of services, and generate state information corresponding to the plurality of services at the first time, microservice request circuitry to query, at a second time, the memory address range to identify a memory address state change, the memory address state change indicative of an instantiation request for at least one of the plurality of services, and microservice instantiation circuitry to cause a first compute device to instantiate the at least one of the plurality of services.

Example 2 includes the apparatus as defined in example 1, wherein the processor circuitry is to instantiate microservice hibernation circuitry to determine whether the at least one of the plurality of services was previously instantiated.

Example 3 includes the apparatus as defined in example 2, wherein the microservice instantiation circuitry is to instantiate the at least one of the previously instantiated services from a cache memory.

Example 4 includes the apparatus as defined in example 2, wherein the processor circuitry is to instantiate resource discover circuitry to identify a plurality of compute devices available to execute the at least one of the plurality of services.

Example 5 includes the apparatus as defined in example 4, wherein the processor circuitry is to instantiate service level agreement (SLA) circuitry to determine whether the first compute device will satisfy SLA parameters.

Example 6 includes the apparatus as defined in example 5, wherein the microservice translation circuitry is to translate the at least one of the plurality of services to execute on a second one of the plurality of compute devices when the SLA parameters are not satisfied in connection with the first compute device.

Example 7 includes the apparatus as defined in example 1, wherein the first compute device includes at least one of the CPU, the GPU, an accelerator, the FPGA, a smart network interface card (NIC), or an infrastructure processing unit (IPU).

Example 7 includes the apparatus as defined in example 1, wherein the plurality of services includes microservices.

Example 8 includes At least one non-transitory computer readable medium comprising instructions that, when executed, cause processor circuitry to at least identify, at a first time, a memory address range corresponding to a plurality of services, build state information corresponding to the plurality of services at the first time, identify, at a second time, the memory address range to identify a memory address state change, the memory address state change indicative of an instantiation request for one of the plurality of services, and cause a first compute device to instantiate the one of the plurality of services.

Example 9 includes the at least one non-transitory computer readable medium as defined in example 8, wherein the instructions, when executed, cause the processor circuitry to determine whether the at least one of the plurality of services was previously instantiated.

Example 10 includes the at least one non-transitory computer readable medium as defined in example 9, wherein the instructions, when executed, cause the processor circuitry to instantiate the at least one of the previously instantiated services from a cache memory.

Example 11 includes the at least one non-transitory computer readable medium as defined in example 9, wherein the instructions, when executed, cause the processor circuitry to identify a plurality of compute devices available to execute the one of the plurality of services.

Example 12 includes the at least one non-transitory computer readable medium as defined in example 11, wherein the instructions, when executed, cause the processor circuitry to determine whether the first compute device will satisfy service level agreement (SLA) parameters.

Example 13 includes the at least one non-transitory computer readable medium as defined in example 12, wherein the instructions, when executed, cause the processor circuitry to translate the one of the plurality of services to execute on a second one of the plurality of compute devices when the SLA parameters are not satisfied in connection with the first compute device.

Example 14 includes the at least one non-transitory computer readable medium as defined in example 8, wherein the plurality of services includes microservices.

Example 15 includes an apparatus to invoke a service, the apparatus comprising means for translating services to query, at a first time, a memory address range corresponding to a plurality of services, and generate state information corresponding to the plurality of services at the first time, means for requesting microservices to query, at a second time, the memory address range to identify a memory address state change, the memory address state change indicative of an instantiation request for at least one of the plurality of services, and means for instantiating microservices to cause a first compute device to instantiate the at least one of the plurality of services.

Example 16 includes the apparatus as defined in example 15, further including means for hibernating services is to determine whether the at least one of the plurality of services was previously instantiated.

Example 17 includes the apparatus as defined in example 16, wherein the means for instantiating microservices is to instantiate the at least one of the previously instantiated services from a cache memory.

Example 18 includes the apparatus as defined in example 16, further including means for discovering resources to identify a plurality of compute devices available to execute the at least one of the plurality of services.

Example 19 includes the apparatus as defined in example 14, further including means for analyzing service level agreements (SLAs) to determine whether the first compute device will satisfy SLA parameters.

Example 20 includes the apparatus as defined in example 19, wherein the means for translating microservices is to translate the at least one of the plurality of services to execute on a second one of the plurality of compute devices when the SLA parameters are not satisfied in connection with the first compute device.

Example 21 includes the apparatus as defined in example 15, wherein the first compute device includes at least one of a central processing unit (CPU) a graphics processing unit (GPU), an accelerator, a field programmable gate array (FPGA), a smart network interface card (NIC) or an infrastructure processing unit (IPU).

Example 22 includes the apparatus as defined in example 15, wherein the plurality of services includes microservices.

Example 23 includes a method comprising extracting, by executing an instruction with processor circuitry at a first time, a memory address range corresponding to a plurality of services, composing, by executing an instruction with the processor circuitry at the first time, state information corresponding to the plurality of services, extracting, by executing an instruction with the processor circuitry at a second time, the memory address range to identify a memory address state change, the memory address state change indicative of an instantiation request for one of the plurality of microservices, and instantiating, by executing an instruction with the processor circuitry, a first compute device to execute the one of the plurality of services.

Example 24 includes the method as defined in example 23, further including determining whether the one of the plurality of services was previously instantiated.

Example 25 includes the method as defined in example 24, further including instantiating, in response to the one of the plurality of services being previously instantiated, at least one of the previously instantiated services from a cache memory.

Example 26 includes the method as defined in example 24, further including detecting a plurality of compute devices available to execute the one of the plurality of services.

Example 27 includes the method as defined in example 26, further including determining whether the first compute device will satisfy service level agreement (SLA) parameters.

Example 28 includes the method as defined in example 27, further including translating the one of the plurality of services to execute on a second one of the plurality of compute devices when the SLA parameters are not satisfied in connection with the first compute device.

Example 29 includes the method as defined in example 23, wherein the first compute device includes at least one of a central processing unit (CPU) a graphics processing unit (GPU), an accelerator, a field programmable gate array (FPGA), a smart network interface card (NIC), or an infrastructure processing unit (IPU).

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to invoke a service, the apparatus comprising:
interface circuitry detect a request to execute the service; and
processor circuitry including one or more of:
at least one of a central processing unit (CPU), a graphic processing unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations;
the processor circuitry to perform at least one of the first operations, the second operations, or the third operations to instantiate:
microservice translation circuitry to:
query, at a first time, a memory address range corresponding to a plurality of services; and
generate state information corresponding to the plurality of services at the first time;
microservice request circuitry to query, at a second time, the memory address range to identify a memory address state change, the memory address state change indicative of an instantiation request for at least one of the plurality of services; and
microservice instantiation circuitry to cause a first compute device to instantiate the at least one of the plurality of services.

2. The apparatus as defined in claim 1, wherein the processor circuitry is to instantiate microservice hibernation circuitry to determine whether the at least one of the plurality of services was previously instantiated.

3. The apparatus as defined in claim 2, wherein the microservice instantiation circuitry is to instantiate the at least one of the previously instantiated services from a cache memory.

4. The apparatus as defined in claim 2, wherein the processor circuitry is to instantiate resource discovery circuitry to identify a plurality of compute devices available to execute the at least one of the plurality of services.

5. The apparatus as defined in claim 4, wherein the processor circuitry is to instantiate service level agreement (SLA) circuitry to determine whether the first compute device will satisfy SLA parameters.

6. The apparatus as defined in claim 5, wherein the microservice translation circuitry is to translate the at least one of the plurality of services to execute on a second one of the plurality of compute devices when the SLA parameters are not satisfied in connection with the first compute device.

7. The apparatus as defined in claim 1, wherein the first compute device includes at least one of the CPU, the GPU, an accelerator, the FPGA, a smart network interface card (NIC), or an infrastructure processing unit (IPU).

8. The apparatus as defined in claim 1, wherein the plurality of services includes microservices.

9. At least one non-transitory computer readable medium comprising instructions that, when executed, cause processor circuitry to at least:
identify, at a first time, a memory address range corresponding to a plurality of services;
build state information corresponding to the plurality of services at the first time;
identify, at a second time, the memory address range to identify a memory address state change, the memory address state change indicative of an instantiation request for one of the plurality of services; and
cause a first compute device to instantiate the one of the plurality of services.

10. The at least one non-transitory computer readable medium as defined in claim 9, wherein the instructions, when executed, cause the processor circuitry to determine whether the at least one of the plurality of services was previously instantiated.

11. The at least one non-transitory computer readable medium as defined in claim 10, wherein the instructions, when executed, cause the processor circuitry to instantiate the at least one of the previously instantiated services from a cache memory.

12. The at least one non-transitory computer readable medium as defined in claim 10, wherein the instructions, when executed, cause the processor circuitry to identify a plurality of compute devices available to execute the one of the plurality of services.

13. The at least one non-transitory computer readable medium as defined in claim 12, wherein the instructions, when executed, cause the processor circuitry to determine whether the first compute device will satisfy service level agreement (SLA) parameters.

14. The at least one non-transitory computer readable medium as defined in claim 13, wherein the instructions, when executed, cause the processor circuitry to translate the one of the plurality of services to execute on a second one of the plurality of compute devices when the SLA parameters are not satisfied in connection with the first compute device.

15. The at least one non-transitory computer readable medium as defined in claim 9, wherein the plurality of services includes microservices.

16. An apparatus to invoke a service, the apparatus comprising:
means for translating services to:
query, at a first time, a memory address range corresponding to a plurality of services; and
generate state information corresponding to the plurality of services at the first time;
means for requesting microservices to query, at a second time, the memory address range to identify a memory address state change, the memory address state change indicative of an instantiation request for at least one of the plurality of services; and
means for instantiating microservices to cause a first compute device to instantiate the at least one of the plurality of services.

17. The apparatus as defined in claim 16, further including means for hibernating services is to determine whether the at least one of the plurality of services was previously instantiated.

18. The apparatus as defined in claim 17, wherein the means for instantiating microservices is to instantiate the at least one of the previously instantiated services from a cache memory.

19. The apparatus as defined in claim 17, further including means for discovering resources to identify a plurality of compute devices available to execute the at least one of the plurality of services.

20. The apparatus as defined in claim 16, further including means for analyzing service level agreements (SLAs) to determine whether the first compute device will satisfy SLA parameters.

21. The apparatus as defined in claim 20, wherein the means for translating microservices is to translate the at least one of the plurality of services to execute on a second one of the plurality of compute devices when the SLA parameters are not satisfied in connection with the first compute device.

22. The apparatus as defined in claim 16, wherein the first compute device includes at least one of a central processing unit (CPU) a graphics processing unit (GPU), an accelerator, a field programmable gate array (FPGA), a smart network interface card (NIC) or an infrastructure processing unit (IPU).

23. The apparatus as defined in claim 16, wherein the plurality of services includes microservices.

24-30. (canceled)
